(19) United States
(12) Patent Application Publication
(10) Pub. No.: US 2018/0143949 A1
(43) Pub. Date: May 24, 2018

(54) Web Content Extension System and Platform

(71) Applicant: Adobe Systems Incorporated, San Jose, CA (US)

(72) Inventors: Joel Andrew Stachowicz, Sandy, UT (US); Serban Andrei Stancu, Lehi, UT (US); Rares Sabin Vlasceanu, Bucharest (RO); Jeffrey Daniel Hicken, Eagle Mountain, UT (US); Corey Spencer, Provo, UT (US); Brandon John Pack, Sandy, UT (US); Mark Allen Hicken, Lehi, UT (US); Jeffrey Raymond Walter, Lehi, UT (US); Evan Michael LaPointe, Atlanta, GA (US); Ben Michael Mills, Lehi, UT (US); Andrei Cristian Ionescu, Bucharest (RO); Aaron Adair Hardy, Pleasant Grove, UT (US)

(73) Assignee: Adobe Systems Incorporated, San Jose, CA (US)

(21) Appl. No.: 15/356,201

(22) Filed: Nov. 18, 2016

(51) Int. Cl. G06F 17/21; H04L 29/08; G06F 17/30; G06F 17/22; G06F 17/27; G06F 17/24

(52) U.S. Cl. CPC G06F 17/218; H04L 67/02; H04L 67/36; G06F 17/3089; G06F 3/04847; G06F 17/272; G06F 17/2725; G06F 17/24; G06F 17/2247

(57) ABSTRACT

A web content extension system and platform is described. Web content extensions include tags as well as actionable code that supports deeper integration with web content than that supported by conventional tags, e.g., through interaction with APIs of the web content. The web content extensions are made available by developers of the extension to content creators via an extension catalog. The extension catalog thus supports a platform that unites developers of the web content extensions with content creators of web content. Further, this platform may be configured to support developer control of integration of the web content extension through use of an extension user interface that is created by the developer.

### BACKGROUND

Tag management systems are designed to manage tags, examples of which include tracking pixels, web beacons, and so on implemented as snippets of HTML code or a dynamically typed runtime language such as JavaScript®. Tags are used to integrate third-party software into web content, such as webpages, mobile applications, video content, and so forth.

One example of the use of tags is in digital marketing systems, such as to support web analytics, campaign analytics, audience measurement, personalization, testing of digital marketing content (e.g., A/B testing), track conversion of goods and services, and so forth. For example, a digital marketing system may configure a tag for inclusion as part of a third-party website. The tag in this example is configured to provide information back to the digital marketing system regarding user interaction with the third-party website. This information may then be used to provide targeted digital marketing content (e.g., banner ads) by the digital marketing system back to the third-party website.

Conventional tag management systems, however, employ techniques that hinder deployment and functionality available from these tags. In one conventional example, a developer may create a tag for inclusion as part of web content. The tag, for instance, may be configured to send data describing users that interact with a webpage and whether the users purchase goods or service from the webpage, i.e., conversion. The developer, in conventional systems, then provides the tag to each individual website that is to deploy the tag.

Engineers at the individual website are then tasked with inclusion of the tags as part of the website, e.g., webpages of the web site. Conventionally, this involves custom coding of the tag for integration as part of the webpage. This custom coding, however, may depart from desires of a developer of the tag and delay implementation of the tag. Thus, the developer in this example has lost control as to how the tag is implemented by the websites, whether the tag will be implemented at all, and is tasked with individualized interaction with each of these websites.

### SUMMARY

Web content extension techniques and systems are described. Web content extensions include tags, such as tracking pixels, web beacons, and so on implemented as snippets of HTML code or a dynamically typed runtime language such as JavaScript®. Web content extensions also include actionable code that supports deeper integration with web content than that supported by conventional tags, e.g., through interaction with APIs of the web content to control routing of data within the web content, custom specification of conditions and actions that are taken in response to those conditions, and so forth.

The web content extensions are made available by developers of the extension to consumers by an online system (e.g., a tag management system) via an extension catalog. The extension catalog, as exposed by the online system, supports a platform that unites developers of the web content extensions with consumers of web content. Further, the extension catalog may be configured to support developer control of integration of the web content extension as part of web content (e.g., webpages, mobile applications) through use of an extension user interface that is created by the developer and exposed by the tag management system, as opposed to conventional techniques that required custom coding to support integration.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures may be indicative of one or more entities and thus reference may be made interchangeably to single or plural forms of the entities in the discussion.

FIG. 1 is an illustration of a digital medium environment in an example implementation that is operable to employ web content extension techniques described herein.

FIGS. 2A and 2B depict systems in an example implementation in which a web content extension is developed and processed for inclusion as part of an extension catalog.

FIGS. 3A, 3B, and 3C depict systems in an example implementation in which the extension catalog is exposed and utilized as part of creation or modification of web content.

FIG. 4 is a flow diagram depicting a procedure in an example implementation in which an online extension catalog of actionable code is managed as part of creation of web content.

FIG. 5 depicts a system in an example implementation in which a web content extension from an extension catalog of a tag management system is integrated as part of web content.

FIG. 6 depicts a procedure in an example implementation in which an online extension catalog is leveraged as part of creation of web content.

FIG. 7 illustrates an example system including various components of an example device that can be implemented as any type of computing device as described and/or utilize with reference to FIGS. 1-6 to implement embodiments of the techniques described herein.

### DETAILED DESCRIPTION

Overview

A web content extension system and platform is described. In an implementation, functionality of a tag management system is extended to support an extension catalog of web content extensions, which are also referred to simply as “extensions” in the following. Web content extensions may include tags as well as actionable code that supports deeper integration with web content than that supported by conventional tags, e.g., through interaction with APIs of the web content to control routing of data both within the web content and outside of the web content. The extension catalog may be used to support a platform by the tag management system to unite developers of the web content extensions with creative professionals and consumers of web content. Further, this platform may be configured to support developer control of integration of the web content extension, as opposed to conventional techniques that required custom coding to support integration.

In one example, a developer system originates a web content extension. The web content extension is formed by the developer system as actionable code configured for inclusion as part of the web content to enhance functionality of the web content. This functionality may include data routing within the web content, cause communication of data to a specified source as a result of user interaction with the web content, and so forth. The web content extension, for instance, may be configured to include a condition (e.g., a custom event) that, when occurs, causes the web content extension to perform an action as part of underlying functionality of the web content. In one example, the condition involves detection of a cursor as hovering over a particular advertisement and the action involves communication of data to a specified location, as set through use of a configuration setting. The data in this instance may describe a user that hovered over the advertisement but did not select the advertisement and subsequently used to target advertising to that user.

As part of developing the web content extension, the developer system may also configure user interface data that is usable to generate a user interface to set configuration settings of the web content extension. Continuing with the previous example, the user interface may be configured to set a particular network address, to which, the data is to be communicated, may specify conditions that are to control communication of the data, may specify which data is communicated, and other configuration settings. In this way, the developer system may originate the web content extension and also define how interaction with the web content extension is performed to integrate the extension as part of web content, e.g., to set the configuration settings. As a result, the developer system is provided with a greater degree of control of how the web content extension is integrated as part of web content.

The web content extension is then provided to a tag management system. The tag management system processes the web content extension and associated user interface data, when available, for inclusion as part of the extension catalog. As part of this, an extension system of the tag management system may validate the extension (e.g., an API specification associated with the extension), test operation of the extension (e.g., execute the extension), parse the extension to determine how to catalog the extension within the extension library, and so forth. Once included in the extension catalog, a representation of the web content extension is exposed by the tag management system to indicate availability of the extension for inclusion as part of web content.

A content creator, for instance, may access the tag management system by a content creation system via a network. The content creation system, for instance, may be configured to create web content, such as a webpage, a mobile application, video content, and so forth. As part of this, a user interface is output by a computing device for viewing by the content creator to create or modify web content (e.g., webpages, mobile applications), which is also configured to select a web content extension for inclusion as part of the web content.

The web content extension, as part of the underlying functionality of the web content, enhances the underlying functionality of the web content through implementation as actionable code. For instance, the content creator may wish to configure the web content to communicate data to a particular location that describes a user that hovers over but does not select an advertisement as described above. Accordingly, the content creator selects a representation of the web content extension created by the developer system from the extension catalog through interaction with a user interface.

In response, an extension user interface is output, as specified by the developer, to configure the web content extension, i.e., to specify configuration settings. Thus, the extension user interface as created by the developer is output within a user interface of the tag management system. Once configured, the web content extension is inserted as part of web content to provide enhanced capabilities of the extension. In this way, functionality of the web content extension is easily included as part of the web content through specification of configuration settings as indicated by a developer of the extension, without requiring custom coding. The web content having the web content extension may then be deployed in a variety of ways. For example, the web content may be deployed by a web content system that created the web content, by a third party content distribution system (e.g., a different website), and so forth for interaction by users of client devices via a network.

Accordingly, consumers may access the extension library as an online platform to include functionality of web content extensions as desired as part of web content. Further, content creators configure these extensions in a manner that is enabled by a developer of the extensions through interaction with the extension user interface created by the developer. The web content extensions may thus be configured to support deeper integration than conventional tags as a result of this developer enablement. Further discussion of this and other examples is included in the following sections and shown in corresponding figures.

In the following discussion, an example environment is first described that may employ the techniques described herein. Example procedures are also described which may be performed in the example environment as well as other environments. Consequently, performance of the example procedures is not limited to the example environment and the example environment is not limited to performance of the example procedures.

Term Examples

“Web content” is digital content configured to support network functionality. Examples of web content include web pages and mobile applications.

“Tags” are used to integrate third-party software into web content, such as webpages, mobile applications, video content, and so forth. Examples of tags include tracking pixels, web beacons, and so on implemented as snippets of HTML code or a dynamically typed runtime language such as JavaScript®.

“Web content extensions” may include tags as well as other actionable code supporting underlying functionality of web content. In an example, a web content extension is formed as actionable code configured for inclusion as part of the web content to cause communication of data to a specified source as a result of user interaction with the web content. The web content extension, for instance, may be configured to include a condition (e.g., a custom event) that, when it occurs, causes the web content extension to communicate data to a particular network address (e.g., URL). Deep integration of the web content extension includes support of communication via APIs of web content that includes the web content extension.

“Extension catalog” refers to an online platform implemented by an online system (e.g., a tag management system) via which web content extensions generated by developers are selectable by content creators for inclusion as part of web content. In an example, the extension catalog includes representations (e.g., names, icons, tiles, and so forth) of web content extensions available from this online platform and supports output of an extension user interface generated by a developer of the extension of specify configuration settings of the extension.

Example Environment

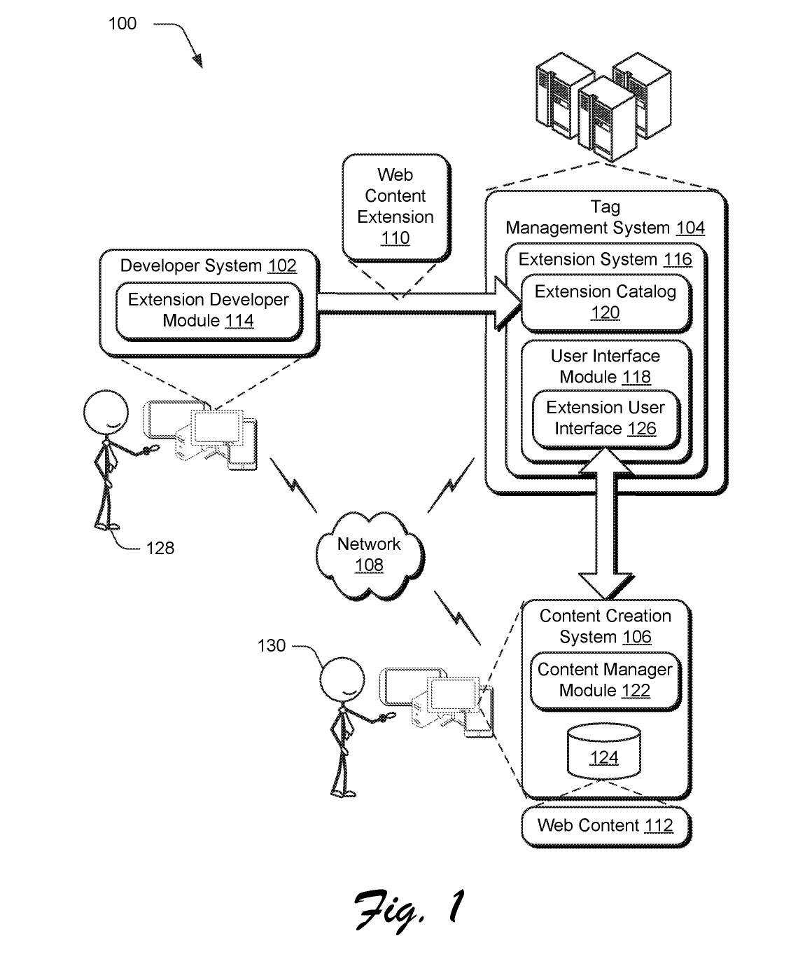

FIG. 1 is an illustration of a digital medium environment 100 in an example implementation that is operable to employ web content extension techniques described herein. The illustrated environment 100 includes a developer system 102, a tag management system 104, and a content creation system 106 that are communicatively coupled, one to another, via a network 108. Each of these entities may be implemented by one or more computing devices.

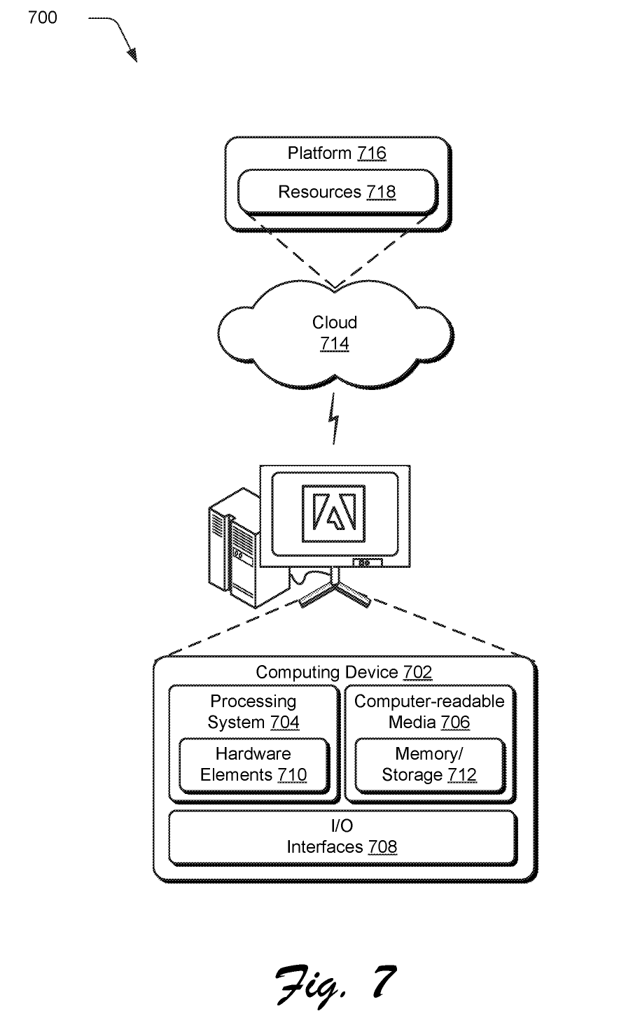

A computing device, for instance, may be configured as a desktop computer, a laptop computer, a mobile device (e.g., assuming a handheld configuration such as a tablet or mobile phone), and so forth. Thus, the computing device may range from full resource devices with substantial memory and processor resources (e.g., personal computers, game consoles) to a low-resource device with limited memory and/or processing resources (e.g., mobile devices). Additionally, the computing device may be representative of a plurality of different devices, such as multiple servers utilized by a business to perform operations “over the cloud”. Further discussion of a computing device is described in relation to FIG. 7.

The tag management system 104 of the digital medium environment 100 is configured to untie developers of web content extensions 110 with content creators that use the web content extensions 110 to create web content 112, such as webpages, mobile applications, and so forth. A developer 128 at the developer system 102, for instance, may generate a web content extension 110 through interaction with an extension developer module 114. The extension developer module 114 is implemented using applications and other functionality that are executed by the developer system 102 and used by the developer 128 to code the web content extension 110.

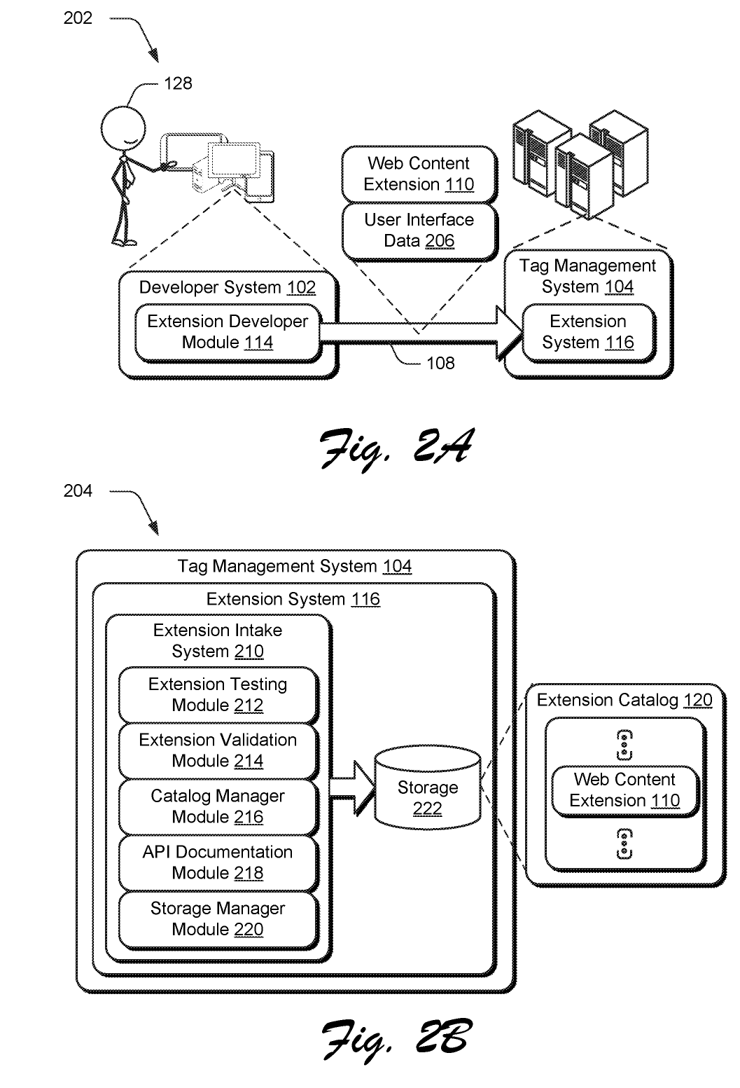

The web content extension 110, once developed by the developer system 102, is then provided by the extension developer module 114 to an extension system 116 of a tag management system 104 via the network 108 as illustrated through use of an arrow in FIG. 1. The extension system 116 processes the web content extension 110 for inclusion in an extension catalog 120, e.g., parses, validates, and tests as further described in relation to FIG. 2B. The extension catalog 120 is then exposed by the extension system 116 via the network 108 to make the web content extension 110 available to the content creation system 106 as part of web content 112.

A creative professional 130, through interaction with a content manager module 122 of the content creation system 106, may then access the extension catalog 120 to select web content extensions 110 for inclusion as part of web content 112, which is illustrated as stored in storage 124. To do so, the content manager module 122 is used to access a user interface module 118 of the tag management system 104 that is configured to output a user interface having representations of the web content extensions 110 available via the catalog. The creative professional 130, through interaction with the user interface module 118, may then select a particular web content extension 110 of interest as actionable code to support underlying functionality of the web content 112. In this way, the creative professional 130 is provided with easy access to an extension catalog 120 of web content extensions 110 created by the developer system 102 to efficiently create web content 112.

As previously described, web content extensions 110 implement actionable code that enhances and supports underlying functionality of web content, such as webpages, mobile applications, and so forth. Web content extensions 110, for instance, include tags, such as tracking pixels, web beacons, and so on implemented as snippets of HTML code or a dynamically typed runtime language such as JavaScript®. Tags are used to integrate third-party software into web content. Typically, tags are used to communicate data via a network 108 to a desired location, such as to describe activities relating to conversion by a webpage to a marketing service system which is then used to provide targeted digital marketing content.

The web content extensions 110 as described herein may also include functionality that was not supported by conventional tags, and thus extends this functionality. As part of developing the web content extensions 110, for instance, the developer system 102 may configure the web content extensions 110 to receive user inputs specifying conditions and resulting actions that are performed when the conditions are met. The web content extensions 110 may also be configured to control routing of data as part of the web content, both within the web content 112 itself as well as external routing of the data. The web content extensions 110 may also be configured to support integration with application programming interfaces of the web content as well as with application programming interfaces of a destination of data that is generated and communicated by the web content extension 110. Thus, web content extensions 110 may also be configured to support deep integration as part of this web content and expand functionality made available as part of the web content 112 through inclusion as part of the web content 112.

The developer system 102 may also specify configuration settings to be set as part of implementation of the web content extension 110, e.g., to integrate the web content extension 110 as part of web content 112 by the creative professional 130 through interaction with the content creation system 106. Configuration settings include specification of particular APIs, conditions (e.g., events) that are to be used to trigger actions, actions that are triggered, destinations of data generated by the extension, and so forth.

In order to set these configuration settings, the developer system 102 may also generate user interface data that, when executed by the tag management system 104, supports output of an extension user interface 126 within the tag management system 104. For example, the extension user interface 126 is configured by the developer 128 and exposed within a user interface output by the user interface module 118 of the tag management system 104. Thus, in this example the tag management system 104 permits a third party (e.g., the developer system 102) to configure the extension user interface 126 to receive user inputs to specify the configuration settings of the web content extension 110.

Once configured, the web content extension 110 is inserted (e.g., integrated) by the tag management system 104 and/or content creation system 106 as part of the web content 112 for deployment to consumers of the web content 112. In this way, the extension catalog 120 may support an online platform to unite developers 128 and content creators 130 to create web content 112 that includes the web content extension 110. An example of development of the web content extension 110, processing of the web content extension 110 for inclusion as part of an extension catalog 120, and exposure of the extension catalog 120 for use as part of creation of web content is described in the following and shown in corresponding figures.

Extension Catalog Online Platform Management

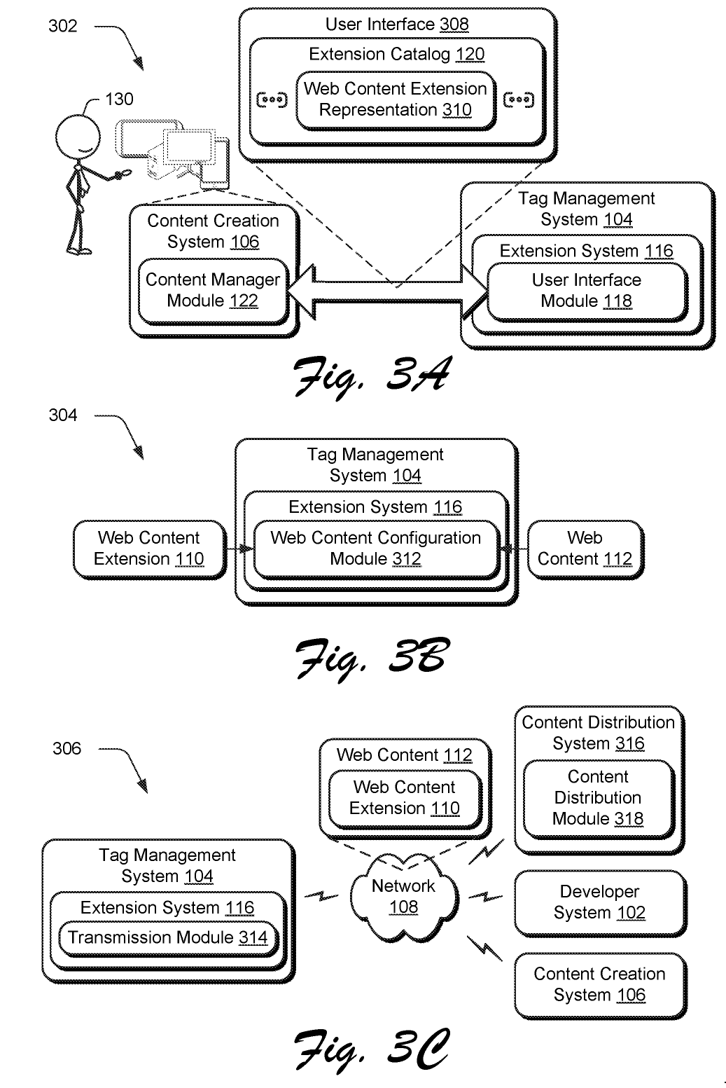

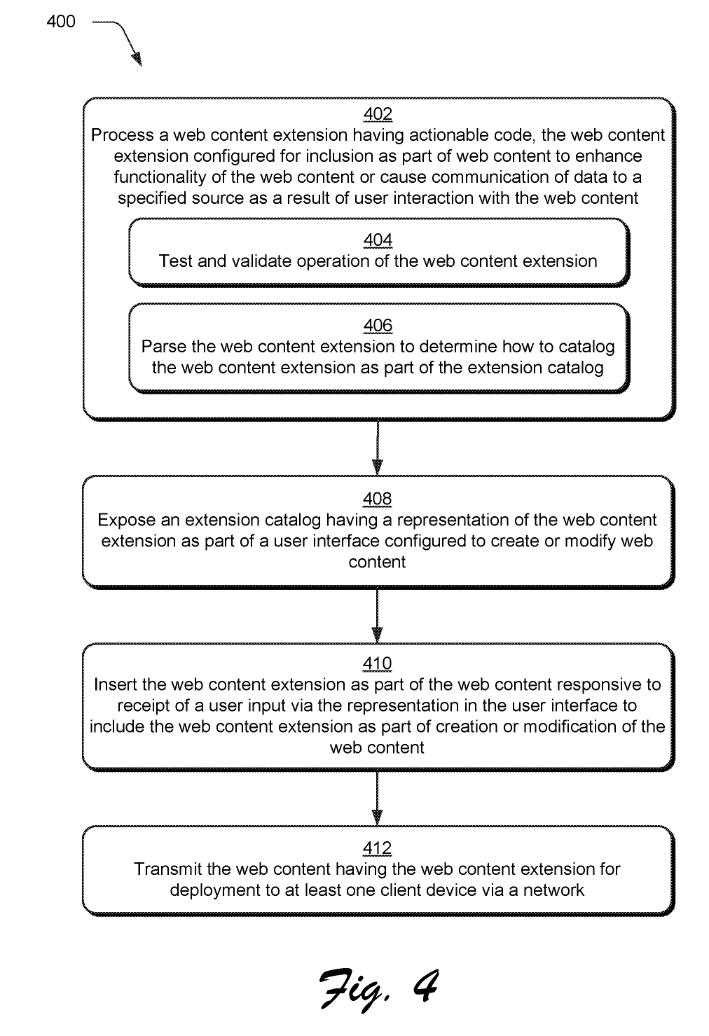

FIGS. 2A and 2B depict systems 202, 204 in an example implementation in which a web content extension is developed and processed for inclusion as part of an extension catalog. FIGS. 3A, 3B, 3C depict systems 302, 304, 306 in an example implementation in which the extension catalog is exposed and utilized as part of creation or modification of web content. FIG. 4 depicts a procedure 400 in an example implementation in which an online extension catalog of actionable code is managed as part of creation of web content.

In general, functionality, features, and concepts described in relation to the examples above and below may be employed in the context of the example procedures described in this section. Further, functionality, features, and concepts described in relation to different figures and examples in this document may be interchanged among one another and are not limited to implementation in the context of a particular figure or procedure. Moreover, blocks associated with different representative procedures and corresponding figures herein may be applied together and/or combined in different ways. Thus, individual functionality, features, and concepts described in relation to different example environments, devices, components, figures, and procedures herein may be used in any suitable combinations and are not limited to the particular combinations represented by the enumerated examples in this description.

To begin at FIG. 2A, a developer interacts with an extension developer module 114 to generate a web content extension 110. The web content extension 110, for instance, may be configured as a tag, examples of which include tracking pixels, web beacons, and so on implemented as snippets of HTML code or a dynamically typed runtime language such as JavaScript®. As previously described, tags are used to integrate third-party software into web content, such as webpages, mobile applications, video content, and so forth. The web content extension 110 may also be configured to support extended functionality over that available via conventional tags. This includes functionality to support custom conditions (e.g., events) and actions that are performed in response to those conditions, to control routing of data by the web content extension 110 (both internal and external), communication via APIs, and to otherwise expand underlying functionality of web content to support deep integration as part of the web content.

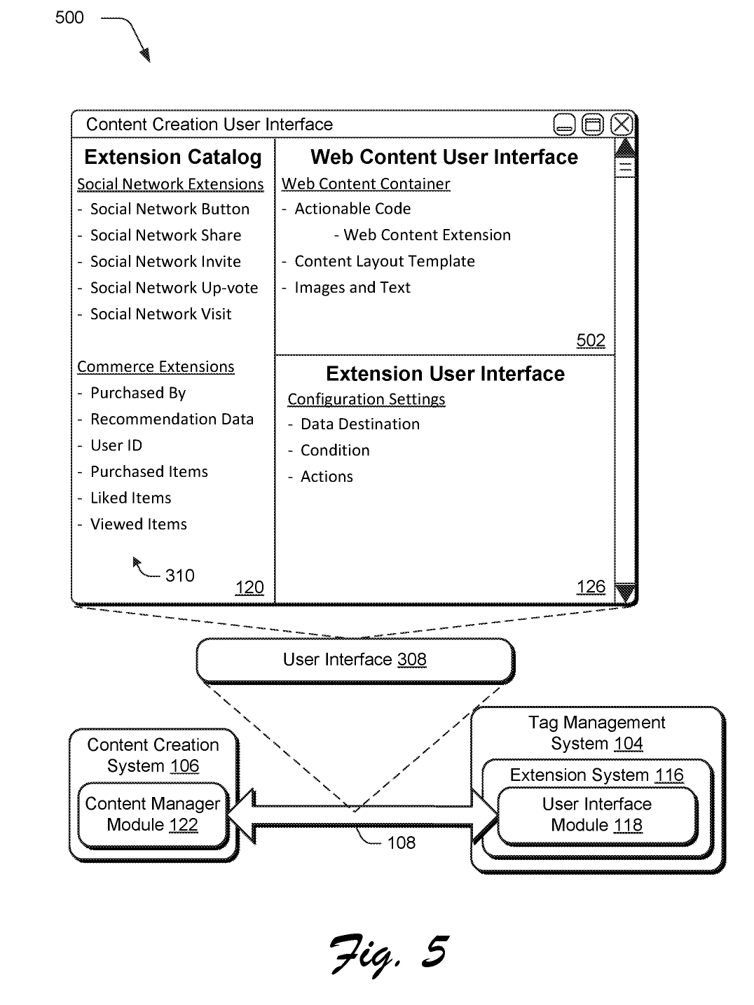

As part of this development, the developer system 102 may also generate user interface data 206. The user interface data 206 is configured to generate an extension user interface 126 of FIG. 1 that is usable to specify configuration settings of the web content extension 106. The extension user interface 126, for instance, may be used to aide interaction of a content creator that subsequently incorporates the web content extension 110 as part of web content 112, as further described in relation to FIG. 5. In this way, the developer 128 associated with the developer system 102 is given a measure of control of implementation of the web content extension 110, which is not possible using conventional techniques as described above that involved custom coding by web content creators.

At FIG. 2B, a web content extension 110 having actionable code is processed. The web content extension 110 is configured for inclusion as part of web content to enhance functionality of the web content or cause communication of data to a specified source as a result of user interaction with the web content 112 (block 402) as described above. Processing of the web content extension 110 (and corresponding user interface data 206 if available) may take a variety of forms as represented by an extension intake system 210.

As part of the processing operation, for instance, the web content extension is tested and validated (block 404). An extension testing module 212, for instance, may be employed by the extension intake system 210 to test that the web content extension 110 operates as intended, e.g., to protect against malicious code as well as for normal operation. This may also be performed through analysis of an API specification to determine which APIs are used by the web content extension 110, e.g., to protect against communications with potentially malicious sources. An extension validation module 214 may also be employed to validate an application programming interface (API) specification, such as to validate the APIs as described in the specification are included and configured as specified in the web content extension 110.

The web content extension is also parsed to determine how to catalog the web content extension as part of the extension catalog (block 406). A catalog manager module 216, for instance, may be used to parse the web content extension 110, APIs, or other documentation associated with the extension through use of an API documentation module 218. This parsing is used to determine a category within the extension catalog 120, to which, the web content extension 110 is to be assigned for exposure via the network to entities that are to employ the web content extension as further described in relation to FIGS. 3A-3C. A storage manager module 220 is then utilized to store the web content extension 110 as part of the extension catalog 120 in storage 222.

After intake by the extension intake system 210, the extension catalog 120 is exposed having a representation of the web content extension as part of a user interface configured to create or modify web content (block 408). At FIG. 3A, for instance, a user interface module 118 of the extension system 116 of the tag management system 104 is configured to expose a user interface 308. The user interface 308 exposes the extension catalog 120 as representations of web content extensions 110 (i.e., web content extension representations 310) that are available via the catalog.

The web content extension 110 is then inserted as part of the web content 112 responsive to receipt of a user input via the representation in a user interface to include the web content extension 110 as part of creation or modification of the web content 112 (block 410). A content creator 130, for instance, may interact with the content manager module 128 of the web content system 106 to select a web content extension representation 310 from the extension catalog 120 in the user interface 308. A corresponding web content extension 110 is then integrated as part of web content 112 as actionable code to expand functionality of the web content 112. IN this way, the creative professional 130 may select from “ready-made” web content extensions 110 generated by developers 128 without custom coding of these extensions.

As shown at FIG. 3B, for instance, the extension system 116 may employ a web content configuration module 312 to integrate the web content extension 110 as part of the web content 112. Although illustrated as part of the tag management system 104, the web content configuration module 312 may also be implemented as part of the content creation system 106 to integrate the web content extension 110 obtained from the tag management system 104. Further discussion of user interaction and integration of the web content extension 110 as part of the web content 112 is included in the following section.

The web content 112 having the web content extension 110 is then transmitted for deployment to at least one client device via a network (block 412). In the illustrated example of FIG. 3C, for instance, the tag management system 104 employs a transmission module 314 to transmit the web content 112 having the web content extension 110 via the network 108 for deployment. This may include deployment by a content distribution system 316 having a content distribution module 318 to deploy webpages, mobile applications (e.g., as part of an online application store), or other configurations of the web content 112. The web content 112 may also be transmitted back to the developer system 102, e.g., as part of a marketing service system, or the content creation system 106 that is used to create the web content 112.

Once deployed, the web content extension 110 communicates data to a specified source as a result of user interaction with the web content. The data, for instance, may be used to track portions of the web content 112 with which the user has interacted. This data may then be used for a variety of purposes, such as to control provision of digital marketing content (e.g., targeted ads) back to a user that interacted with that web content.

Integration of a Web Content Extension from an Extension Catalog

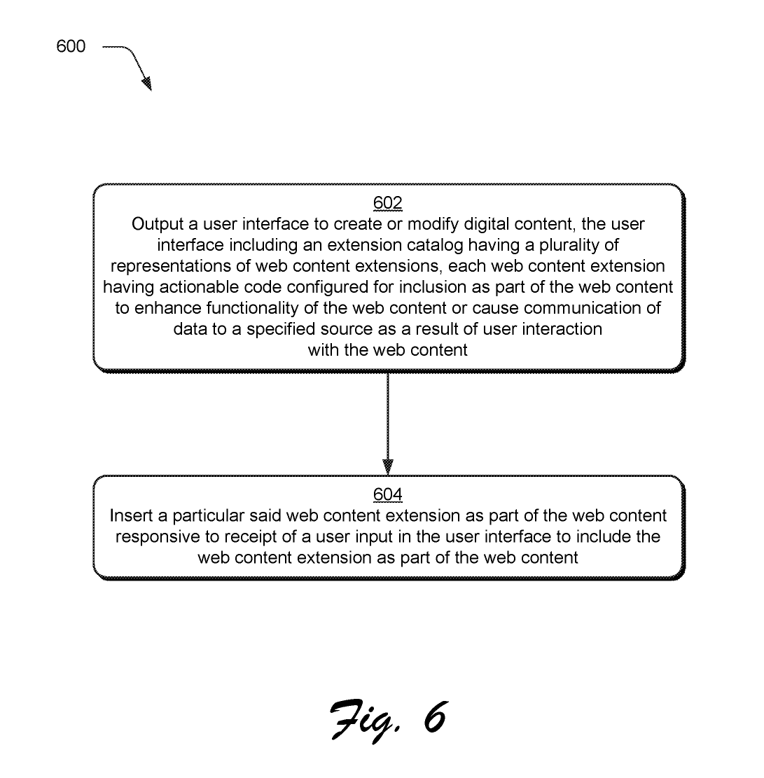

FIG. 5 depicts a system 500 in an example implementation in which a web content extension 110 from an extension catalog 120 of the tag management system 104 is integrated as part of web content 112. FIG. 6 depicts a procedure 600 in an example implementation in which an online extension catalog is leveraged as part of creation of web content.

As shown in the system 500 of FIG. 1, a user interface 308 is output to create or modify web content. In this example, the user interface 308 is output by the tag management system 104 for interaction by a content creator through use of a content creation system 106 via a network 108.

The user interface 128 includes an extension catalog 120 having a plurality of representations 310 of web content extensions. Each represented web content extension 310 includes actionable code that is configured for inclusion as part of the web content to cause communication of data to a specified source as a result of user interaction with the web content (block 602) as previously described. The extension catalog 120 is illustrated as having categories of types of web content extensions as a result of the parsing by the extension intake system 210.

A user may then select a representation 310 of a desired web content extension for inclusion as part of web content. A web content user interface 502, for instance, may also be included to generate a web content container having a content layout template that is used to specify a layout of images and text. The web content container also includes actionable code that supports the underlying functionality to the web content, such as data routing, interaction with APIs, and so forth. This also includes integration of a particular web content extension selected through choice of a corresponding representation (e.g., icon, name) from the extension catalog 120.

As part of this integration, an extension user interface 126 is output within the user interface 308 to specify configuration settings of the selected web content extension. As previously described, the extension user interface 126 is configured by a developer of the web content extension and thus provides a mechanism for the developer to control how content creators incorporate the extension as part of the content. The content creator, through interaction with the extension user interface 126 may specify a destination of data generated by the extension, a condition that is to serve as a basis to perform an action, the actions that are performed through execution of the extension, and so forth. Thus, the content creator may select representations of desired web content extensions having desired functionality without custom coding this functionality, thereby improving efficiency and robustness of content creation.

Once configured, the web content extension 110 is inserted (e.g., integrated) as part of the web content 112 responsive to receipt of a user input in the user interface to include the web content extension 110 as part of the web content 112 (block 604). A user, for instance, may add this configured web content extension to the web content via the web content user interface 502. The web content may then be deployed as described in the previous section.

Example System and Device

FIG. 7 illustrates an example system generally at 700 that includes an example computing device 702 that is representative of one or more computing systems and/or devices that may implement the various techniques described herein. The computing device 702 may be, for example, a server of a service provider, a device associated with a client (e.g., a client device), an on-chip system, and/or any other suitable computing device or computing system.

The example computing device 702 as illustrated includes a processing system 704, one or more computer-readable media 706, and one or more I/O interface 708 that are communicatively coupled, one to another. Although not shown, the computing device 702 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 704 is representative of functionality to perform one or more operations using hardware. Accordingly, the processing system 704 is illustrated as including hardware element 710 that may be configured as processors, functional blocks, and so forth. This may include implementation in hardware as an application specific integrated circuit or other logic device formed using one or more semiconductors. The hardware elements 710 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 706 is illustrated as including memory/storage 712. The memory/storage 712 represents memory/storage capacity associated with one or more computer-readable media. The memory/storage component 712 may include volatile media (such as random access memory (RAM)) and/or nonvolatile media (such as read only memory (ROM), Flash memory, optical disks, magnetic disks, and so forth). The memory/storage component 712 may include fixed media (e.g., RAM, ROM, a fixed hard drive, and so on) as well as removable media (e.g., Flash memory, a removable hard drive, an optical disc, and so forth). The computer-readable media 706 may be configured in a variety of other ways as further described below.

Input/output interface(s) 708 are representative of functionality to allow a user to enter commands and information to computing device 702, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 702 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 702. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 702, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 710 and computer-readable media 706 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 710. The computing device 702 may be configured to implement particular instructions and/or functions corresponding to the software and/or hardware modules. Accordingly, implementation of a module that is executable by the computing device 702 as software may be achieved at least partially in hardware, e.g., through use of computer-readable storage media and/or hardware elements 710 of the processing system 704. The instructions and/or functions may be executable/operable by one or more articles of manufacture (for example, one or more computing devices 702 and/or processing systems 704) to implement techniques, modules, and examples described herein.

The techniques described herein may be supported by various configurations of the computing device 702 and are not limited to the specific examples of the techniques described herein. This functionality may also be implemented all or in part through use of a distributed system, such as over a “cloud” 714 via a platform 716 as described below.

The cloud 714 includes and/or is representative of a platform 716 for resources 718. The platform 716 abstracts underlying functionality of hardware (e.g., servers) and software resources of the cloud 714. The resources 718 may include applications and/or data that can be utilized while computer processing is executed on servers that are remote from the computing device 702. Resources 718 can also include services provided over the Internet and/or through a subscriber network, such as a cellular or Wi-Fi network.

The platform 716 may abstract resources and functions to connect the computing device 702 with other computing devices. The platform 716 may also serve to abstract scaling of resources to provide a corresponding level of scale to encountered demand for the resources 718 that are implemented via the platform 716. Accordingly, in an interconnected device embodiment, implementation of functionality described herein may be distributed throughout the system 700. For example, the functionality may be implemented in part on the computing device 702 as well as via the platform 716 that abstracts the functionality of the cloud 714.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. In a digital medium environment to manage an online catalog of extensions of actionable code as part of creation of web content, a system comprising:
an extension intake system, implemented at least partially in hardware of at least one computing device, to process a web content extension having actionable code, the web content extension configured for inclusion as part of web content to cause communication of data to a specified source as a result of user interaction with the web content or enhance functionality of the web content;
a user interface module implemented at least partially in hardware of at least one computing device to expose an extension catalog and a representation of the web content extension as part of a user interface configured to create or modify web content; and
a web content configuration module implemented at least partially in hardware of at least one computing device to insert the web content extension as part of the web content responsive to receipt of a user input via the representation in the user interface to include the web content extension as part of creation or modification of the web content.

2. The system as described in claim 1, wherein the extension intake system further processes user interface data configured to output an extension user interface to specify a configuration setting of the web content extension.

3. The system as described in claim 2, wherein the user interface module is further configured to:
receive at least one user input initiated via interaction with the extension user interface to specify the configuration setting of the web content extension; and
configure the web content extension to have the specified configuration setting and wherein the inserted web content extension has the specified configuration setting.

4. The system as described in claim 1, wherein the extension intake system further comprises a storage manager module to control storage of the web content extension as part of the extension catalog.

5. The system as described in claim 4, wherein the extension intake system further comprises an extension testing module and an extension validation module to test and validate, respectively, operation of the web content extension.

6. The system as described in claim 1, wherein the extension intake system further comprises a catalog manager module to parse the web content extension to determine how to catalog the web content extension as part of the extension catalog.

7. The system as described in claim 1, further comprising a transmission module to transmit the web content having the web content extension for deployment to at least one client device via a network.

8. The system as described in claim 1, wherein the web content extension is configured according to a dynamically-typed runtime language.

9. The system as described in claim 1, wherein the web content is a webpage or mobile application.

10. In a digital medium environment to create or modify web content to include a web content extension from an online catalog implemented via a platform, a method implemented by at least one computing device, a method comprising:
outputting, by the at least one computing device, a user interface to create or modify web content, the user interface including an extension catalog having a plurality of representations of web content extensions, each said web content extension having actionable code configured for inclusion as part of the web content to cause communication of data to a specified source as a result of user interaction with the web content or enhance functionality of the web content; and
inserting, by the at least one computing device, a particular said web content extension as part of the web content responsive to receipt of a user input in the user interface to include the web content extension as part of the web content.

11. The method as described in claim 10, wherein the web content extension is configured according to a dynamically-typed runtime language and wherein the web content is a webpage.

12. The method as described in claim 10, wherein an extension user interface is output within the user interface and further comprising:
receiving, by the at least one computing device, at least one user input initiated via interaction with the extension user interface to specify a configuration setting of the particular said web content extension; and
configuring, by the at least one computing device, the particular said web content extension to have the specified configuration setting and wherein the inserted particular said web content extension has the specified configuration setting.

13. The method as described in claim 10, wherein the at least one computing device is implemented as part of a tag management system.

14. The method as described in claim 10, wherein the at least one computing device is implemented as part of developer device that accesses the extension catalog via a network.

15. In a digital medium environment to manage an online catalog of extensions of actionable code as part of creation of web content, a system comprising:
means for processing a web content extension having actionable code, the web content extension configured for inclusion as part of web content to enhance functionality of the web content;
means for exposing an extension catalog and a representation of the web content extension as part of a user interface configured to create or modify web content; and
means for inserting the web content extension as part of the web content responsive to receipt of a user input via the representation in the user interface to include the web content extension as part of creation or modification of the web content.

16. The system as described in claim 15, wherein the processing means is further configured to process user interface data, received with the web content extension, configured to output an extension user interface to specify a configuration setting of the web content extension.

17. The system as described in claim 15, wherein the processing means further comprises means for controlling storage of the web content extension as part of the extension catalog.

18. The system as described in claim 15, wherein the processing means further comprises means for testing operation of the web content extension and means for validating operation of the web content extension.

19. The system as described in claim 15, wherein the processing means further comprises means for parsing the web content extension to determine how to catalog the web content extension as part of the extension catalog.

20. The system as described in claim 15, wherein the web content extension is configured according to a dynamically-typed runtime language and the web content is a webpage.
